(19) United States
(12) Patent Application Publication
(10) Pub. No.: US 2016/0170891 A1
(43) Pub. Date: Jun. 16, 2016

(54) DISK APPARATUS AND CONTROL METHOD

(71) Applicant: Kabushiki Kaisha Toshiba, Tokyo (JP)

(72) Inventors: Michio Yamamoto, Inagi Tokyo (JP); Isao Fujita, Yokohama Kanagawa (JP); Takumi Kakuya, Ebina Kanagawa (JP); Masami Tashiro, Komae Tokyo (JP); Yuka Kuwano, Yokohama Kanagawa (JP); Takato Kuji, Yokohama Kanagawa (JP); Katsushi Ohta, Kawasaki Kanagawa (JP); Seiji Toda, Kawasaki Kanagawa (JP)

(21) Appl. No.: 14/638,979

(22) Filed: Mar. 4, 2015

Related U.S. Application Data
(60) Provisional application No. 62/090,727, filed on Dec. 11, 2014.

(51) Int. Cl. G06F 12/08; G06F 3/06

(52) U.S. Cl. CPC G06F 12/0871; G06F 3/0619; G06F 3/0635; G06F 3/0653; G06F 3/0656; G06F 3/0658; G06F 3/068; G06F 2212/1032; G06F 2212/202; G06F 2212/21; G06F 2212/222; G06F 2212/253; G06F 2212/281; G06F 2212/313; G06F 2212/604

(57) ABSTRACT

According to one embodiment, there is provided a disk apparatus including a disk medium, a nonvolatile memory, and a controller. In the nonvolatile memory, data to be recorded to the disk medium is written. The controller is configured to perform, according to amount of free space of the nonvolatile memory, write process of the data in the nonvolatile memory collectively, or in multiple times with dividing the write process.

### CROSS-REFERENCE TO RELATED APPLICATIONS

This application is based upon and claims the benefit of priority from U.S. Provisional Application No. 62/090,727, filed on Dec. 11, 2014; the entire contents of which are incorporated herein by reference.

### FIELD

Embodiments described herein relate generally to a disk apparatus and control method.

### BACKGROUND

In disk apparatuses, write process may be performed on a disk medium. If a cutoff or drop in supply power supplied externally (an external power-supply cutoff) occurs during write process, it is desired to protect data on which the write process has not yet finished.

### BRIEF DESCRIPTION OF THE DRAWINGS

FIG. 1 is a block diagram showing configuration of a disk apparatus according to an embodiment;

FIG. 2 is a sequence diagram showing an operation (in a first mode) before a power-supply cutoff occurs of the disk apparatus according to the embodiment;

FIG. 3 is a sequence diagram showing an operation (in a second mode) before a power-supply cutoff occurs of the disk apparatus according to the embodiment;

FIG. 4 is a flow chart showing an operation before a power-supply cutoff occurs of the disk apparatus according to the embodiment;

FIG. 5 is a diagram showing an operation (in the first mode) when a power-supply cutoff occurs of the disk apparatus according to the embodiment;

FIG. 6 is a diagram showing an operation (in the first mode) after the power supply returns of the disk apparatus according to the embodiment;

FIG. 7 is a diagram showing an operation (in the second mode) when a power-supply cutoff occurs of the disk apparatus according to the embodiment;

FIG. 8 is a diagram showing an operation (in the second mode) after the power supply returns of the disk apparatus according to the embodiment; and

FIG. 9 is a flow chart showing an operation when a power-supply cutoff occurs of the disk apparatus according to the embodiment.

### DETAILED DESCRIPTION

In general, according to one embodiment, there is provided a disk apparatus including a disk medium, a nonvolatile memory, and a controller. In the nonvolatile memory, data to be recorded to the disk medium is written. The controller is configured to perform, according to amount of free space of the nonvolatile memory, write process of the data in the nonvolatile memory collectively, or in multiple times with dividing the write process.

Exemplary embodiments of a disk apparatus will be explained below in detail with reference to the accompanying drawings. The present invention is not limited to the following embodiments.

### Embodiment

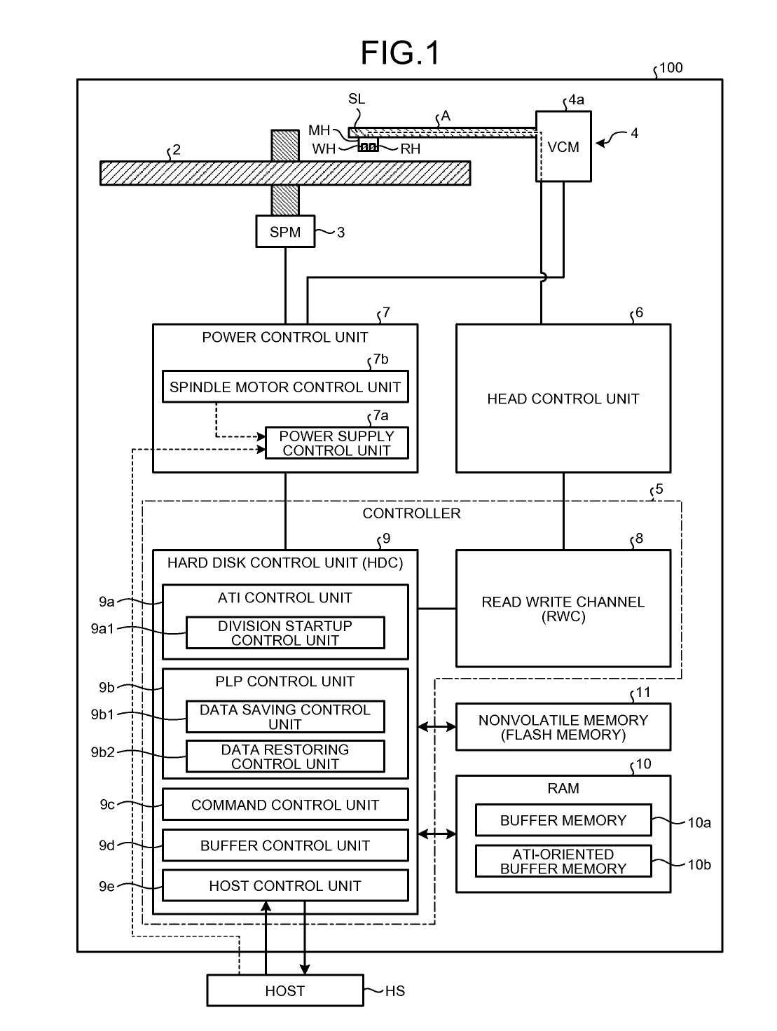

A disk apparatus 100 according to an embodiment will be described using FIG. 1. FIG. 1 is a block diagram showing configuration of the disk apparatus 100.

The disk apparatus 100 is, for example, a hard disk drive and functions as an external storage apparatus for a host HS.

Specifically, the disk apparatus 100 includes a disk medium 2, a spindle motor (SPM) 3, a magnetic head MH, an actuator arm A, a voice coil motor (VCM) 4, a controller 5, a head control unit 6, a power control unit 7, a random access memory (RAM) 10, and a nonvolatile memory 11. The controller 5 includes a read write channel (RWC) 8 and a hard disk control unit (HDC) 9. Note that the hard disk control unit (HDC) 9 can include a CPU (F/W) and a logic circuit (HDC).

The disk medium 2 is a disc-shaped recording medium (e.g., a magnetic disk) onto which to record a variety of information and is rotationally driven by the SPM 3. The disk medium 2 has a perpendicular recording layer having magnetic anisotropic in a direction substantially perpendicular to the surface. The disk medium 2 has multiple tracks shaped like concentric circles with the center near the rotation center of the SPM 3, for example. The multiple tracks can be grouped into concentric circle-shaped zones to be managed.

Reading from and writing onto the disk medium 2 are performed by the magnetic head MH provided via a head slider SL on one end of the actuator arm A that is a head support mechanism. The magnetic head MH includes a write head WH and a read head RH.

The magnetic head MH, keeping state of being slightly lifted from the surface of the disk medium 2 by lift force generated by the rotation of the disk medium 2, moves relative to the surface of the disk medium 2 in a down track direction. The write head WH records information onto the disk medium 2. The read head RH reads information recorded on the disk medium 2.

The actuator arm A pivots on an arc with an axis 4a as the center by driving of the VCM 4, which is a head drive mechanism provided at the other end of the actuator arm A. With this configuration, the magnetic head MH moves in a cross-track direction of the disk medium 2 to switch tracks subject to reading or writing.

The power control unit 7 controls electric power in the disk apparatus 100. The power control unit 7 has a power supply control unit 7a and a spindle motor control unit 7b. The power supply control unit 7a receives supply power from the host HS and supplies a power supply based on the received supply power to each part of the disk apparatus 100. The spindle motor control unit 7b controls rotation of the SPM 3. The power control unit 7 controls driving of the VCM 4.

The power supply control unit 7a detects occurrence of a cutoff of supply power from the host HS or a drop of such a degree that the disk apparatus 100 cannot continue operating (hereinafter both referred to as a power-supply cutoff). When detecting the occurrence of a power-supply cutoff, the power supply control unit 7a notifies the occurrence of a power-supply cutoff to the HDC 9 and receives a counter-electromotive force due to rotation of the SPM 3 via the spindle motor control unit 7b. The power supply control unit 7a supplies the received counter-electromotive force as an auxiliary power supply to the each part of the disk apparatus 100.

Note that where the disk apparatus 100 has a battery, a capacitor, or the like, supply power from the battery or capacitor may be used as an auxiliary power supply in addition to or instead of the counter-electromotive force due to the rotation of the SPM 3.

Further, the power supply control unit 7a detects a resupply of supply power from the host HS (hereinafter referred to as a power-supply return). When detecting a power-supply return, the power supply control unit 7a notifies the power-supply return to the HDC 9 and supplies a power supply based on the resupplied supply power to each part of the disk apparatus 100.

The HDC 9 performs control such as control according to a command received from the host HS, ATI (Adjacent Track Interference) control, and PLP (Power Loss Protection) control. The ATI is a phenomenon where, if write process is performed on a given track of the disk medium 2 in the disk apparatus 100, the signal of an adjacent track degrades. The ATI control is control for dealing with the ATI. The PLP control is control that, if a power-supply cutoff occurs during write process, saves data on which the write process is being performed into the nonvolatile memory 11 to prevent the data from being lost. The HDC 9 has an ATI control unit 9a, a PLP control unit 9b, a command control unit 9c, a buffer control unit 9d, and a host control unit 9e.

The RAM 10 functions as a cache memory to store data temporarily, and a volatile memory (e.g., a DRAM, SRAM, etc.) that can be accessed at high speed is used. The RAM 10 has a buffer memory 10a and a ATI-oriented buffer memory 10b.

The command control unit 9c performs process according to a command and data received from the host HS via the host control unit 9e. For example, when receiving a write command and write data, the command control unit 9c performs write process according to the write command. That is, the command control unit 9c controls the buffer control unit 9d according to the write command. The buffer control unit 9d temporarily stores the write data in the buffer memory 10a according to control by the command control unit 9c and reads the stored write data from the buffer memory 10a to transfer to the RWC 8. The RWC 8 writes the write data onto the disk medium 2 by the write head WH via the head control unit 6. That is, the controller 5 performs write process (first write process) according to the write command.

The ATI control unit 9a performs process for dealing with ATI. For example, the ATI control unit 9a manages, for each zone, the number of write times for the tracks belonging to the zone. That is, all the tracks that the disk medium 2 has, are divided into multiple concentric circle-shaped zones. Each zone contains multiple tracks. The ATI control unit 9a counts the number of write times for each zone and, if this count exceeds a predetermined threshold, data refresh is performed on the tracks belonging to the zone. For example, the ATI control unit 9a performs read process to read data from each track of the zone of interest and temporarily stores the read data in the ATI-oriented buffer memory 10b via the buffer control unit 9d. The ATI control unit 9a transfers the stored data as write data from the ATI-oriented buffer memory 10b to the RWC 8 via the buffer control unit 9d. The RWC 8 writes the write data onto the disk medium 2 via the write head WH. That is, the controller 5 performs rewrite process (second write process) to rewrite data read from each track of the zone of interest as write data onto the track.

The ATI control unit 9a has a division startup control unit 9a1. The division startup control unit 9a1 controls rewrite operation included in process for dealing with ATI in preparation for the occurrence of a power-supply cutoff. Tactics in the rewrite operation will be described later.

When a power-supply cutoff occurs, the PLP control unit 9b performs the PLP control using the auxiliary power supply supplied from the power supply control unit 7a. The PLP control unit 9b has a data saving control unit 9b1 and a data restoring control unit 9b2.

If receiving notification of the occurrence of a power-supply cutoff from the power supply control unit 7a (in response to receiving it), the data saving control unit 9b1 saves write data in the buffer memory 10a into the nonvolatile memory 11. That is, the data saving control unit 9b1 saves write data subject to write process (first write process) according to the write command and management information about it (e.g., address information or the like) into the nonvolatile memory 11. The nonvolatile memory 11 stores the saved write data and management information about it therein.

If receiving notification of a power-supply return from the power supply control unit 7a (in response to receiving it), the data restoring control unit 9b2 rewrites the write data saved in the nonvolatile memory 11 based on the management information saved in the nonvolatile memory 11 onto the disk medium 2.

As the nonvolatile memory 11, for example, a flash memory is used to store data in a nonvolatile manner. As the nonvolatile memory 11, a nonvolatile memory such as an FeRAM, MRAM, ReRAM, or PRAM may be used instead of the flash memory.

Here, consider a comparative example. It is desired to protect not only write data subject to write process (first write process) according to a write command but also write data subject to rewrite process (second write process) for dealing with ATI if a power-supply cutoff occurs in the disk apparatus 100. For example, a dedicated area to be used for a purpose other than recording write data subject to first write process is provided on the disk medium 2. In preparation for the case where a power-supply cutoff occurs during data rewrite process (second write process) for dealing with ATI, rewrite data is written onto the dedicated area on the disk medium 2 before rewrite process is performed. If a power-supply cutoff occurs during rewrite process, and thus sector data being rewritten becomes unreadable, it is possible to restore the rewrite data using data saved on the dedicated area on the disk medium 2.

Where data is saved onto the dedicated area, it takes a predetermined time (e.g., about several tens msec) to perform operations such as seek to a data storing track, a rotation wait, and writing. With this method of dealing with ATI, a delay in rewrite process is likely to occur due to data saving operation, and hence the performance of the disk apparatus 100 may be greatly affected with an increase in the time during which a user cannot access data subject to rewrite process, or so on.

In this embodiment, if a power-supply cutoff occurs during rewriting for dealing with ATI, rewrite data is saved into the nonvolatile memory 11 using the PLP control.

In the PLP control, there is a limit to the amount of data that can be saved in the nonvolatile memory 11. Further, if a timing when data is saved into the nonvolatile memory 11 in other process (e.g., the first write process) of the disk apparatus 100 and a timing when operation for dealing with ATI (e.g., the second write process) is performed overlap, then the amount of rewrite data, in dealing with ATI, that can be saved in the nonvolatile memory 11 changes depending on the amount of data in the other process.

Further, the range of data to be saved into the nonvolatile memory 11 at a power-supply cutoff during rewrite process for dealing with ATI, changes depending on the situation for the rewrite process. The range of data on the disk medium 2 which cannot be guaranteed differs, for example, between a power-supply cutoff after write operation is normally performed and a power-supply cutoff during a retry of write operation (during rewrite operation).

Accordingly, in this embodiment, the controller 5 ascertains (predicts) the amount of free space of the nonvolatile memory 11 and switches the startup of rewrite process between a single write (a first mode) and divided writes (a second mode) according to the amount of free space. The first mode is a mode in which the second write process (rewrite process for dealing with ATI) is performed collectively. The second mode is a mode in which the second write process is divided into multiple times of process and performed. Thus, in any situation for the rewrite process, rewrite data can be saved into the nonvolatile memory 11 by the PLP control.

Specifically, the amount of data that can be saved into the nonvolatile memory 11 by the PLP control during rewrite process for dealing with ATI is calculated as the remaining amount other than the data amount used as a PWC (Persistent Write Cache). Note that, because the data amount used for the PWC changes depending on the situation for the command process, the necessary area in rewrite operation for dealing with ATI is not always secured. For example, if a write error occurs during ATI rewriting, and rewrite process is performed in retry, then the area for the rewrite process must be secured as the remaining amount, but for the above reason, the remaining amount may not be enough. However, it can be confirmed before rewrite process for dealing with ATI that the remaining amount is not enough, and if the remaining amount is less than the maximum data amount in rewrite process, then the data amount in the rewrite process for dealing with ATI is limited to match the remaining amount. Thus, write data subject to rewrite process can be saved into the nonvolatile memory 11 by the PLP control.

For example, the controller 5 obtains the data amount to be spent in the nonvolatile memory 11 when write data subject to the first write process (write process according to a write command) and management information about it are saved by the PLP control. For example, if already-used data (such as management information about the first write process) is in the nonvolatile memory 11, then the controller 5 obtains a data amount that is the sum of the amount of the data (data usage amount) and the data amount (secured data amount) to be spent by write data subject to the first write process and management information about it. The controller 5 subtracts the obtained data amount (the data usage amount+the secured data amount) from the storage capacity of the nonvolatile memory 11 to obtain the amount of free space (PLP savable data amount). The controller 5 switches the mode in which the second write process (rewrite process for dealing with ATI) onto the disk medium 2 is performed between the first mode and the second mode according to the obtained amount of free space.

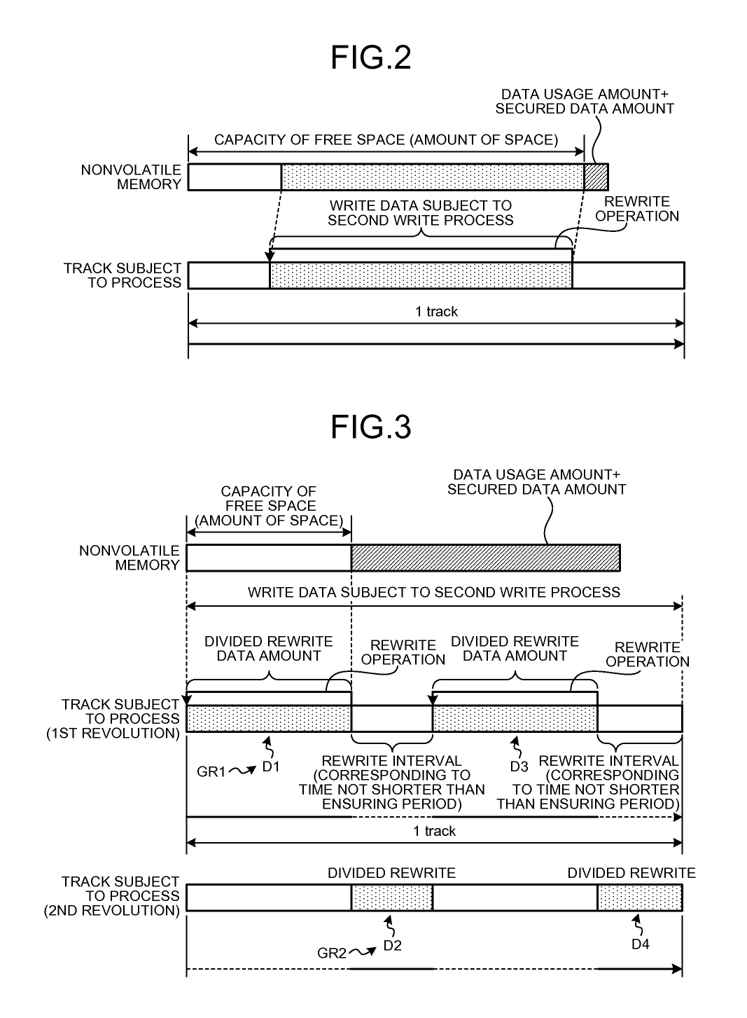

If the size of write data subject to the second write process (and management information about the second write process) is less than or equal to the amount of free space as shown in FIG. 2, then the controller 5 performs the second write process in the first mode. That is, in the controller 5, the second mode in which divided rewrites are performed by the division startup control unit 9a1 is not used if the size of write data subject to the second write process is less than or equal to the amount of free space. FIG. 2 is a diagram showing the operation (in the first mode) of the disk apparatus 100 before a power-supply cutoff occurs. The controller 5 performs write operation on a track subject to process collectively in the first mode.

On the other hand, if the size of write data subject to the second write process (and management information about the second write process) is greater than the amount of free space as shown in FIG. 3, then the controller 5 performs the second write process in the second mode. That is, in the controller 5, the division startup control unit 9a1 starts up the second mode in which divided rewrites are performed if the size of write data subject to the second write process is greater than the amount of free space. FIG. 3 is a diagram showing the operation (in the second mode) of the disk apparatus 100 before a power-supply cutoff occurs. The controller 5, in the second mode, divides write data subject to the second write process into multiple data blocks D1 to D4 having a size (data amount) less than or equal to the amount of free space and performs multiple times of write operation that correspond to the divided data blocks D1 to D4 for the second write process. That is, the data blocks D1 to D4 are write data subject to the second write process. Although FIG. 3 illustrates the case where data to be rewritten on a track subject to process is divided into four, the number of divisions is not limited to four.

Here, limiting the amount of data to be rewritten for dealing with ATI so as to match the amount of free space of the nonvolatile memory 11, may cause a revolution wait. If rewrite process is divided into four, i.e., four times of write operation, and for each write operation, the magnetic head MH is made to revolve once along the track subject to process, then for each revolution, there occurs about one revolution worth of a wait after the execution of a write operation until the execution of the next write operation. Thus, four revolutions along the track subject to process is needed, and hence it takes four times the length of time for the original rewrite process.

In contrast, in the present embodiment, the controller 5 rewrites divided data at intervals. For example, where rewrite process is divided into multiple times of rewrite operation, after the completion of a rewrite operation is confirmed, rewrite operation for the next divided range needs to be started. In order to reduce a delay in finishing rewriting all the data by this divided rewrite operation, after the completion of a rewrite operation, the controller 5 ascertains a division location at which it can start next and starts rewrite operation. Because servo information written on the disk medium 2 is used in confirming the completion of a rewrite operation, after the completion of a rewrite operation onto the disk medium 2 and before the completion of the confirmation, the time for ascertaining servo information on the track is needed. The interval (rewrite interval) of rewrite areas on the track subject to process needs to be one corresponding to a time longer than or equal to an ensuring period. The ensuring period is one which ensures that the controller 5 has become ready to start the next write operation after finishing a write operation. The ensuring period includes servo-information-ascertaining time and preparation time for starting the next writing. The servo-information-ascertaining time is time determined depending on a servo interval. The preparation time includes the time for the controller 5 to obtain the next write location on the track subject to process.

That is, the interval of servo information (servo interval) for each track on the disk medium 2 and the preparation time that the controller 5 takes to prepare for the next write operation are acquired through experiment beforehand and set in the controller 5. The controller 5 determines the servo-information-ascertaining time according to the servo interval on the track subject to process and obtains the ensuring period of the track subject to process according to the servo-information-ascertaining time and the preparation time. Further, the controller 5 obtains the data amount (number of sectors) corresponding to the ensuring period for the track subject to process.

The controller 5, in the second mode, divides write data subject to the second write process into multiple data blocks D1 to D4 having a data amount (number of sectors) larger than or equal to the data amount corresponding to the ensuring period. The controller 5 extracts every other data block from the divided data blocks D1 to D4 and performs multiple times of write operation that correspond to a first group GR1 including the not-extracted data blocks D1, D3 and a second group GR2 including the extracted data blocks D2, D4.

For example, as shown in FIG. 3, the controller 5 can perform write operation on the data blocks D1, D3 belonging to the first group GR1 in the first revolution of the track subject to process and perform write operation on the data blocks D2, D4 belonging to the second group GR2 in the second revolution of the track subject to process. The controller 5 need revolve twice along the track subject to process while performing write operation at time intervals longer than or equal to the ensuring period for each revolution, so that rewrite process can be finished in twice the length of time for the original rewrite process, and hence a decrease in the performance of the disk apparatus 100 can be suppressed. Although FIG. 3 illustrates the case where write operation is performed in the order of the first group GR1 and the second group GR2, the controller 5 may perform write operation on the data blocks D2, D4 belonging to the second group GR2 in the first revolution of the track subject to process and perform write operation on the data blocks D1, D3 belonging to the first group GR1 in the second revolution of the track subject to process. Further, although FIG. 3 illustrates the case where the range for which to perform rewrite process on the track subject to process is within one track, the range for which to perform rewrite process may be within less than one track or distributed over multiple tracks, not being limited to within one track.

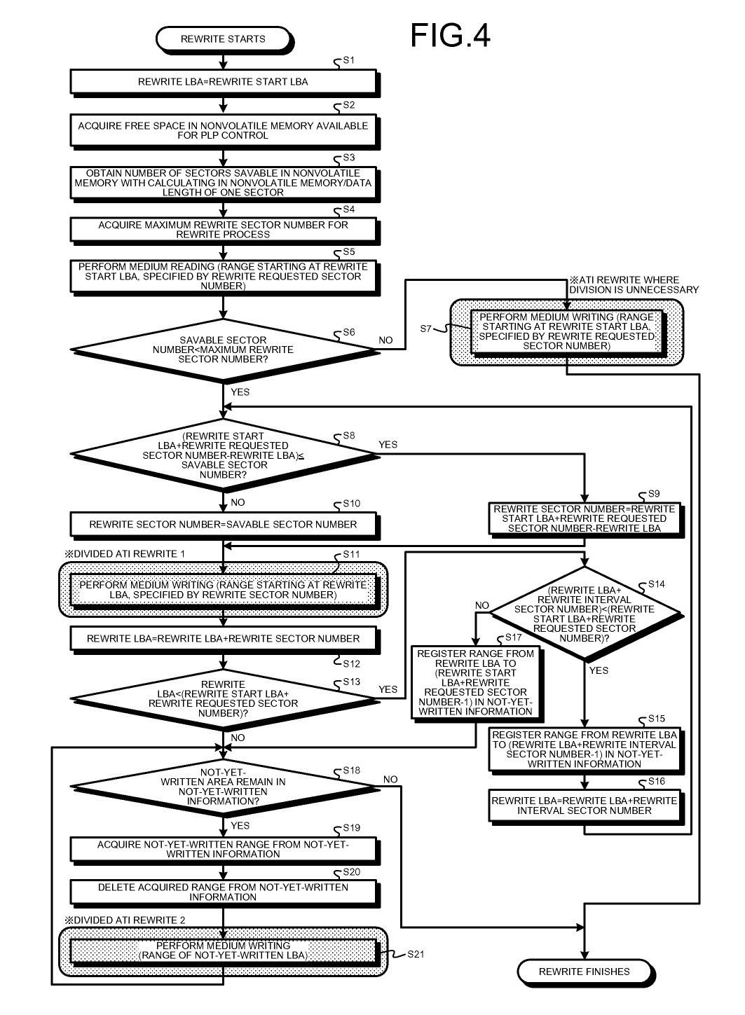

More specifically, the disk apparatus 100 operates as shown in FIG. 4. FIG. 4 is a flow chart showing the operation of the disk apparatus 100 before a power-supply cutoff occurs.

The controller 5 counts the number of write times for the tracks belonging to a zone and, if this count exceeds a predetermined threshold, determines the logical address (rewrite LBA) of a start location to perform rewrite process (the second write process) in data refresh. For example, the controller 5 selects a track to be processed from the tracks belonging to the zone whose count exceeds the threshold and determines the logical address (rewrite start LBA) of the lead location of the selected track to be the rewrite LBA (S1).

The operation of saving write data subject to the first write process (write process according to a write command) and management information about it into the nonvolatile memory 11 by the PLP control is not performed before a power-supply cutoff occurs. Hence, the controller 5 ascertains the size of write data subject to the first write process and management information about it stored in the buffer memory 10a to obtain the amount of space to be spent in the nonvolatile memory 11 if write data subject to the first write process and management information about it are saved by the PLP control. The controller 5 subtracts the obtained amount of space from the storage capacity of the nonvolatile memory 11 to obtain the amount of free space. That is, the controller 5 acquires the data capacity of free space in the nonvolatile memory 11 available to the second write process (rewrite process for dealing with ATI) for the PLP control (S2).

The controller 5 divides the capacity of free space in the nonvolatile memory 11 by the data amount of one sector of the track subject to process. Thereby, the controller 5 obtains the number of sectors (savable sector number) of the track subject to process which can be saved in the free space of the nonvolatile memory 11 (S3).

The controller 5 obtains the number of sectors onto which the controller 5 is requested to rewrite (rewrite requested sector number) in rewrite process (the second write process) in the refresh process. That is, the controller 5 acquires the rewrite requested sector number that is the maximum rewrite sector number for the second write process (S4).

The controller 5 performs reading data from sectors subject to rewriting in the second write process on the disk medium 2 (medium reading) (S5). For example, the controller 5 reads data in the range starting at the rewrite start LBA determined at S1 and specified by the rewrite requested sector number on the track subject to process of the disk medium 2.

The controller 5 compares the savable sector number obtained at S3 and the maximum rewrite sector number acquired at S4 to determine whether the maximum rewrite sector number is greater than the savable sector number (S6). If the maximum rewrite sector number is less than or equal to the savable sector number (No at S6), the controller 5 sets the mode in which to perform the second write process at the first mode. The controller 5 performs writing data onto sectors subject to rewriting in the second write process on the disk medium 2 (medium writing) in the first mode (S7). For example, the controller 5 rewrites data in the range starting at the rewrite start LBA determined at S1 and specified by the rewrite requested sector number on the track subject to process of the disk medium 2 collectively.

On the other hand, if the maximum rewrite sector number is greater than the savable sector number (Yes at S6), the controller 5 sets the mode in which to perform the second write process at the second mode and performs the second write process by multiple times of divided rewrite operation. The controller 5 performs the process of S8 to S21 in the second mode.

Specifically, the controller 5 realizes the logical address (rewrite LBA) of the lead location to perform the next divided rewrite operation and determines whether the number of remaining sectors to rewrite onto is less than or equal to the savable sector number (S8). At this time, the following equation 1 holds.

(The number of remaining sectors to rewrite onto)=(rewrite requested sector number)−(already-rewritten sector number)=(rewrite requested sector number)−{(rewrite LBA)−(rewrite start LBA)}=(rewrite start LBA)+(rewrite requested sector number)−(rewrite LBA) Eq. 1

Here, in the equation 1, the rewrite start LBA is the logical address of the start location for the second write process determined at S1.

If the number of remaining sectors to rewrite onto is less than or equal to the savable sector number (Yes at S8), the controller 5 sets the number of remaining sectors to rewrite onto, as it is, as the number of sectors to perform the next divided rewrite operation (rewrite sector number) (S9).

On the other hand, if the number of remaining sectors to rewrite onto is greater than the savable sector number (No at S8), the controller 5 sets the savable sector number as the number of sectors to perform the next divided rewrite operation (rewrite sector number) (S10).

The controller 5 performs writing data onto sectors subject to divided rewriting on the disk medium 2 (medium writing) in the second mode (S11). For example, the controller 5 rewrites data in the range starting at the rewrite LBA realized at S8 and specified by the rewrite sector number set at S9 or S10 on the track subject to process of the disk medium 2. For example, where multiple times of divided rewrite operation are performed on the track subject to process in two revolutions, divided rewrite operation of the first revolution is performed.

The controller 5 sets the logical address that is the rewrite sector number added to the rewrite LBA as the logical address (rewrite LBA) of the end location for divided rewrite operation of this time (S12).

The controller 5 determines whether the rewrite LBA (the end location for divided rewrite operation of this time) set at S12 is before the end location for the second write process (S13). At this time, the following equation 2 holds.

(The end location for the second write process)=(rewrite start LBA)+(rewrite requested sector number) Eq. 2

In the equation 2, the rewrite start LBA is the logical address of the start location for the second write process determined at S1.

If the rewrite LBA is before the end location for the second write process (Yes at S13), the controller 5 determines whether a rewrite interval sector number added to the rewrite LBA (the start location for the next divided rewrite operation) is before the end location for the second write process (S14). The rewrite interval sector number is the number of sectors included in the rewrite interval. For example, the rewrite interval sector number is obtained by dividing the rewrite interval by the length of one sector of the track subject to process. The rewrite interval is determined beforehand as an interval corresponding to a time longer than or equal to the ensuring period by the controller 5.

If the start location for the next divided rewrite operation is before the end location for the second write process (Yes at S14), the controller 5 registers the address range ‘from the rewrite LBA to the rewrite LBA+the rewrite interval sector number−1’ in not-yet-written information (S15). For example, where multiple times of divided rewrite operation are performed on the track subject to process in two revolutions, the address range of data block D2, which is to be division rewritten in the second revolution, is registered in the not-yet-written information immediately after divided rewrite operation in the first revolution for data block D1 (see FIG. 3).

The controller 5 sets the rewrite interval sector number added to the rewrite LBA (the start location for the next divided rewrite operation) as the rewrite LBA (S16) and makes the process return to S8.

On the other hand, if the start location for the next divided rewrite operation is after the end location for the second write process (No at S14), the controller 5 registers the address range ‘from the rewrite LBA to the rewrite start LBA+the rewrite requested sector number−1’ in the not-yet-written information (S17) and makes the process proceed to S18.

The controller 5 determines whether an area on which rewrite operation has not been performed (a not-yet-written area) remains among the areas registered in the not-yet-written information (S18). For example, where multiple times of divided rewrite operation are performed on the track subject to process in two revolutions, the address ranges of data blocks D2, D4 which are to be division rewritten in the second revolution, are registered in the not-yet-written information immediately after divided rewrite operation in the first revolution for data block D3 (see FIG. 3). If a not-yet-written area does not remain in the not-yet-written information (No at S18), the controller 5 finishes the process.

If a not-yet-written area remains in the not-yet-written information (Yes at S18), the controller 5 acquires an address range (not-yet-written range) on which to perform divided rewrite operation next from the not-yet-written information (S19). For example, immediately after divided rewrite operation in the first revolution for data block D3, the address range of data block D2 which is to be division rewritten in the second revolution is acquired (see FIG. 3).

The controller 5 deletes the address range acquired at S19 from the not-yet-written information (S20). For example, if the address range of data block D2 is acquired at S19, the address range of data block D2 is deleted from the not-yet-written information.

The controller 5 performs writing data onto sectors subject to divided rewriting on the disk medium 2 (medium writing) in the second mode (S21). For example, the controller 5 rewrites data in the address range acquired at S19 on the track subject to process of the disk medium 2. For example, when the address range of data block D2 is acquired at S19, the controller 5 performs divided rewrite operation on data in the address range of data block D2.

Next, the operation of the disk apparatus 100 when a power-supply cutoff occurs will be described.

When a power-supply cutoff occurs, the controller 5 saves write data subject to the first write process into the nonvolatile memory 11. The controller 5 reads out write data subject to the first write process from the buffer memory 10a and writes the read-out write data into the nonvolatile memory 11. When the power supply is resumed, the controller 5 reads out the saved write data subject to the first write process from the nonvolatile memory 11 and rewrites the read-out write data onto the disk medium 2.

Further, when a power-supply cutoff occurs, the controller 5 saves at least part of write data subject to the second write process (rewrite process for dealing with ATI) into the nonvolatile memory 11. The controller 5 reads out at least part of write data subject to the second write process from the ATI-oriented buffer memory 10b and writes the read-out write data into the nonvolatile memory 11. When the power supply is resumed, the controller 5 reads out the saved write data subject to the second write process from the nonvolatile memory 11 and rewrites the read-out write data onto the disk medium 2.

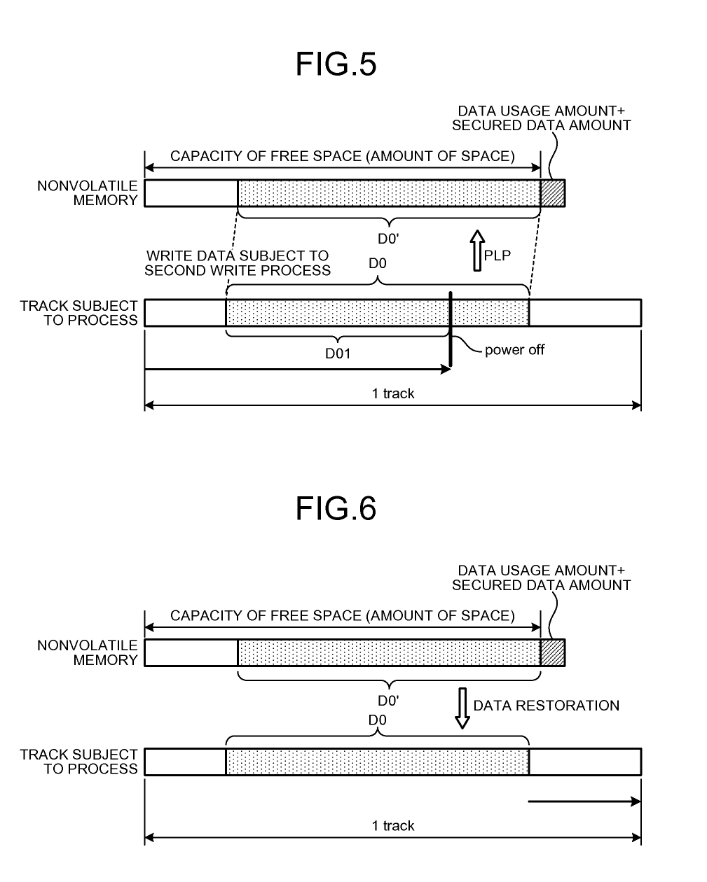

For example, if a power-supply cutoff occurs while the second write process is being performed in the first mode, the controller 5 saves all write data subject to the second write process into the nonvolatile memory 11 using the PLP control as shown in FIG. 5. FIG. 5 is a diagram showing the operation (in the first mode) of the disk apparatus 100 when a power-supply cutoff occurs. For example, if a power-supply cutoff occurs at the timing when rewrite operation for a part D01 going from the start to halfway out of write data D0 has finished, then the controller 5 saves all write data D0 and management information into free space of the nonvolatile memory 11. The management information includes information (rewrite start LBA) about the location at which the write data D0 was written on the disk medium 2. The nonvolatile memory 11 stores the saved write data D0′ in its free space.

Then, when the power supply is resumed (the power supply returns), the controller 5 reads out the saved write data subject to the second write process from the nonvolatile memory 11 and rewrites the read-out write data onto the disk medium 2 as shown in FIG. 6. FIG. 6 is a diagram showing the operation (in the first mode) of the disk apparatus 100 after the power supply returns. For example, the controller 5 reads out the write data D0′ and management information from the nonvolatile memory 11 and rewrites the write data D0 onto the disk medium 2 at the location (rewrite start LBA) according to the management information. With this operation, the write data D0 is restored on the disk medium 2.

In contrast, in divided rewrite operation (the second mode) for rewrite data, the controller 5 divides write data subject to the second write process into multiple divided data of a size not greater than the amount of free space of the nonvolatile memory 11. The controller 5 needs to repeat the cycle of rewriting divided data, ascertaining servo information, and setup process continuously until rewriting all the rewrite data is finished. If a power-supply cutoff occurs during rewrite operation, the controller 5 needs to save rewrite data and, after the power supply is resumed, to restore the saved data to finish divided rewrite operation.

If a power-supply cutoff occurs during rewrite process for divided data, the controller 5 ascertains the implementation status of rewrite operation. If determining that the rewrite process for the divided data has not yet been finished, the controller 5 saves current divided data into the nonvolatile memory 11. The controller 5 ascertains the management information in the nonvolatile memory 11 when the power supply is resumed next. If all divided rewrite operation has not been finished, the controller 5 writes the saved data stored in the nonvolatile memory 11 onto the disk medium 2 to finish a restoring process for the divided data. After the restoring process for the divided data is finished, if rewrite operation for the rest is necessary, the controller 5 may determine whether rewriting for the remaining divided data needs to be divided again or perform rewrite process in the same way as above.

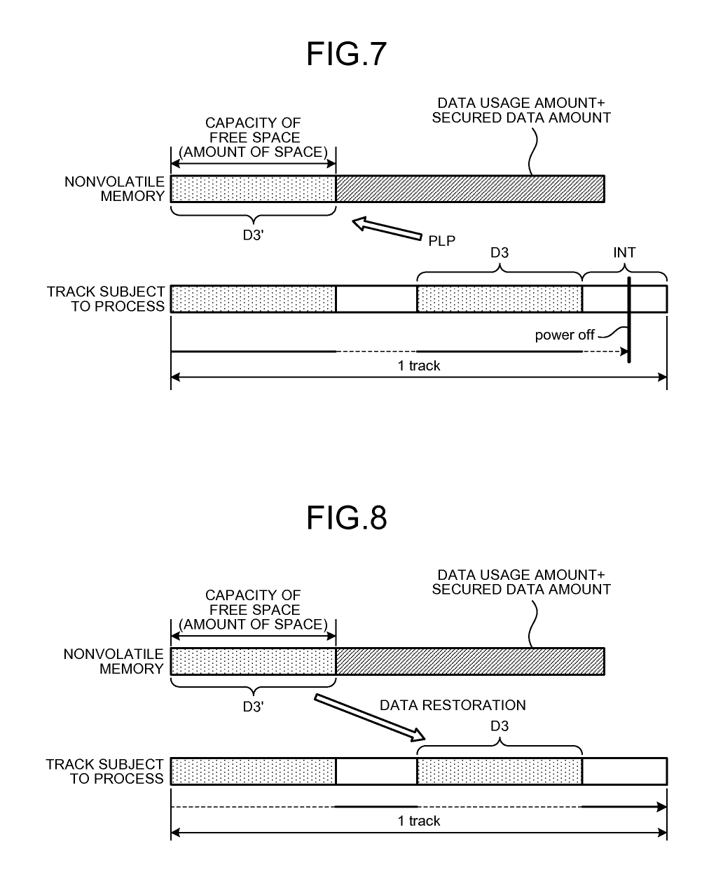

For example, if a power-supply cutoff occurs while the second write process is being performed in the second mode, the controller 5 saves a data block (divided data) subjected to rewrite operation at the timing of the power-supply cutoff into the nonvolatile memory 11 using the PLP control as shown in FIG. 7. FIG. 7 is a diagram showing the operation (in the second mode) of the disk apparatus 100 when a power-supply cutoff occurs. If a power-supply cutoff occurs during the period (rewrite interval) between a rewrite operation and the next rewrite operation in the second mode, then the controller 5 saves the data block subjected to rewrite operation immediately before this rewrite interval into the nonvolatile memory 11. For example, if a power-supply cutoff occurs during the rewrite interval INT after rewrite operation for data block D3 finishes and before rewrite operation for the next data block D2 (see FIG. 3) is performed, then the controller 5 saves data block D3 and management information about it into free space of the nonvolatile memory 11. The management information includes information (the start LBA of data block D3) about the location at which data block D3 was written on the disk medium 2. The nonvolatile memory 11 stores the saved data block D3′ in its free space.

Then, when the power supply is resumed (the power supply returns), the controller 5 reads out the saved data block D3′ from the nonvolatile memory 11 and rewrites the read-out data block D3′ onto the disk medium 2 as shown in FIG. 8. FIG. 8 is a diagram showing the operation (in the second mode) of the disk apparatus 100 after the power supply returns. For example, the controller 5 reads out the data block D3′ and management information from the nonvolatile memory 11 and rewrites the data block D3 onto the disk medium 2 at the location (the start LBA of data block D3) according to the management information. By this means, the data block D3 is restored on the disk medium 2.

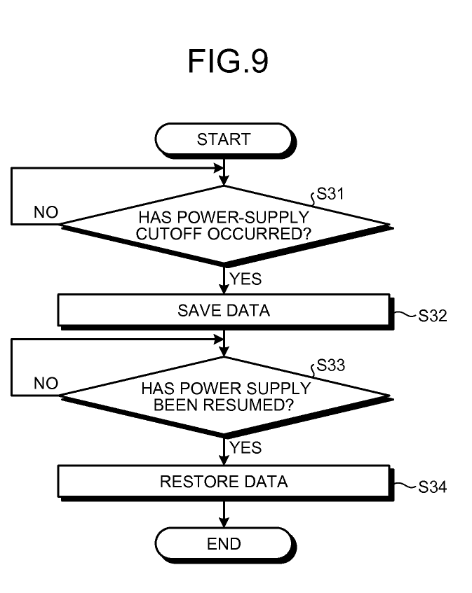

More specifically, the disk apparatus 100 operates as shown in FIG. 9. FIG. 9 is a flow chart showing the operation of the disk apparatus 100 after a power-supply cutoff occurs.

The controller 5 detects supply power supplied from the host HS and determines whether a power-supply cutoff has occurred according to the detected supply power (S31). The controller 5 waits until the level of the detected supply power becomes less than a predetermined threshold level (while No at S31). The predetermined threshold level is, for example, the lower limit of the power level with which the disk apparatus 100 can continue operating.

When the level of the detected supply power becomes less than the predetermined threshold level, the controller 5 determines that a power-supply cutoff has occurred (Yes at S31) and saves data according to the PLP control. That is, the controller 5 operates using the auxiliary power supply to save write data subject to the first write process and at least part of write data subject to the second write process (rewrite process for dealing with ATI) into the nonvolatile memory 11 (S32).

For example, if a power-supply cutoff occurs while the second write process is being performed in the first mode, the controller 5 saves all write data subject to the second write process and management information into the nonvolatile memory 11 according to the PLP control (see FIG. 5). That is, the controller 5 reads out all write data subject to the second write process from the ATI-oriented buffer memory 10b and writes all the read-out write data and management information into the nonvolatile memory 11.

Or, for example, if a power-supply cutoff occurs while the second write process is being performed in the second mode, the controller 5 saves the data block subjected to rewrite operation at the timing of the power-supply cutoff into the nonvolatile memory 11 according to the PLP control. If a power-supply cutoff occurs during rewrite operation, the controller 5 reads the data block subjected to rewrite operation that was being performed at the timing when the power-supply cutoff occurred from the ATI-oriented buffer memory 10b. If a power-supply cutoff occurs during the period (rewrite interval) between a rewrite operation and the next rewrite operation, then the controller 5 reads out the data block subjected to write operation immediately before the period (rewrite interval) during which the power-supply cutoff occurred from the ATI-oriented buffer memory 10b. The controller 5 writes the read-out data block and management information into the nonvolatile memory 11 (see FIG. 7).

Then the controller 5 detects supply power supplied from the host HS and determines whether the power supply has been resumed according to the detected supply power (S33). The controller 5 waits until the level of the detected supply power becomes greater than or equal to a predetermined threshold level (while No at S33).

When the level of the detected supply power becomes greater than or equal to the predetermined threshold level, the controller 5 determines that the power supply has been resumed (Yes at S33) and restores data according to the PLP control. That is, the controller 5 reads out the saved write data subject to the first write process or the saved data block subject to the second write process from the nonvolatile memory 11 and rewrites the read-out write data or data block onto the disk medium 2 (S34).

For example, the controller 5 reads out the write data D0 and management information from the nonvolatile memory 11 and rewrites the write data D0 onto the disk medium 2 at the location (start LBA) according to the management information (see FIG. 6).

Or, for example, the controller 5 reads out the data block D3 and management information from the nonvolatile memory 11 and rewrites the data block D3 onto the disk medium 2 at the location (the start LBA of data block D3) according to the management information (see FIG. 8).

As described above, in the disk apparatus 100 of the embodiment, the controller 5 switches between the first mode and the second mode according to the amount of free space of the nonvolatile memory 11. The first mode is a mode in which the second write process is performed collectively. The second mode is a mode in which the second write process is divided into multiple times of process and performed. For example, if the size of write data subject to the second write process is less than or equal to the amount of free space of the nonvolatile memory 11, then the controller 5 performs the second write process in the first mode. On the other hand, if the size of write data subject to the second write process is greater than the amount of free space of the nonvolatile memory 11, then the controller 5 performs the second write process in the second mode. Thus, if a power-supply cutoff occurs during write operation in internal tasks of the disk apparatus 100 such as data-rewrite process for dealing with ATI, the PLP control can be executed to prevent a sector being rewritten onto from becoming unreadable. That is, for example, as compared with the case where rewrite data is saved into a dedicated area on the disk medium 2, the time required for write operation including data protection can be shortened, and a time during which a user cannot access data subject to rewrite process can be shortened, and so on, which means that the performance of the disk apparatus 100 can be improved.

Further, in the embodiment, the controller 5, in the second mode, divides write data subject to the second write process into multiple data blocks having a size less than or equal to the amount of free space of the nonvolatile memory 11. The controller 5 performs multiple times of write operation that correspond to the divided data blocks for the second write process. Thus, even if the entire size of write data subject to the second write process is greater than the amount of free space of the nonvolatile memory 11, the data blocks subject to rewriting can be reliably saved into the nonvolatile memory 11 by the PLP control in response to the occurrence of a power-supply cutoff.

Yet further, in the embodiment, the controller 5, in the second mode, performs multiple times of write operation at time intervals longer than or equal to the ensuring period. That is, the controller 5 determines the ensuring period according to the time for ascertaining servo information and the time for preparing for the next write operation. The controller 5 divides write data subject to the second write process into multiple data blocks having a data amount corresponding to a time interval longer than or equal to the ensuring period. The controller 5 extracts every other data block from the divided data blocks and performs multiple times of write operation that correspond to the first group GR1 including the not-extracted data blocks D1, D3 and the second group GR2 including the extracted data blocks D2, D4. That is, the controller 5 performs write operation on the data blocks D1, D3 belonging to the first group GR1 in the first revolution of a track subject to process and perform write operation on the data blocks D2, D4 belonging to the second group GR2 in the second revolution of the track subject to process. Thus, the controller 5 need revolve twice along the track subject to process while performing write operation at time intervals longer than or equal to the ensuring period for each revolution, so that rewrite process can be finished in twice the length of time for the original rewrite process, and hence a decrease in the performance of the disk apparatus 100 can be suppressed.

Note that the controller 5 may compare the size of write data subject to the second write process and the amount of free space of the nonvolatile memory 11 during each predetermined period and wait to start performing the second write process until operation in the first mode becomes possible according to the comparing result. That is, the controller 5 may wait to start performing the second write process until the size of write data subject to the second write process becomes less than or equal to the amount of free space of the nonvolatile memory 11 according to the comparing result. In this case, in response to the size of write data subject to the second write process becoming less than or equal to the amount of free space of the nonvolatile memory 11, the controller 5 starts performing the second write process in the first mode. For example, in the flow chart shown in FIG. 4, the controller 5 waits until the answer becomes No at S6 and, when the answer becomes No at S6, makes the process proceed to S7. At this time, the process of S8 to S21 is not performed. Thus, the contents of the control by the controller 5 can be simplified.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A disk apparatus comprising:
a disk medium;
a nonvolatile memory in which data to be recorded to the disk medium is written; and
a controller configured to perform, according to amount of free space of the nonvolatile memory, write process of the data in the nonvolatile memory collectively, or in multiple times with dividing the write process.

2. The disk apparatus of claim 1, wherein
the controller performs the write process for the data to be recorded, according to amount of free space of the nonvolatile memory after write data subject to other write process to the disk medium is saved in the nonvolatile memory.

3. The disk apparatus of claim 2, wherein
when size of the data to be recorded is less than or equal to the amount of the free space, the controller performs write process of the data collectively and, when the size of the data is greater than the amount of the free space, performs the write process of the data in multiple times.

4. The disk apparatus of claim 3, wherein
when the size of the data to be recorded is greater than the amount of the free space, the controller divides the data into multiple data blocks of a size less than or equal to the amount of the free space and performs multiple times of write operations that correspond to the multiple divided data blocks.

5. The disk apparatus of claim 4, wherein
when the size of the data to be recorded is greater than the amount of the free space, the controller performs the multiple times of write operation at time intervals longer than or equal to a period which ensures that a next write operation is possible after the write operation is finished.

6. The disk apparatus of claim 5, wherein
when the size of the data to be recorded is greater than the amount of the free space, the controller divides the data to be recorded into multiple data blocks of a size corresponding to the time interval.

7. The disk apparatus of claim 5, wherein
the period includes time to check servo information and time for preparing for next write operation.

8. The disk apparatus of claim 4, wherein
when the size of the data to be recorded is greater than the amount of the free space, the controller extracts every other data block from the multiple divided data blocks and performs multiple times of write operations that correspond to a first group including a not-extracted data blocks and a second group including a extracted data blocks.

9. The disk apparatus of claim 8, wherein
the controller, after performing write operation of data blocks belonging to one of the first group and the second group to a track subject to process, in a next revolution, performs write operation for data blocks belonging to another of the first group and the second group.

10. The disk apparatus of claim 1, wherein
the controller operates using an auxiliary power supply when an external power-supply cutoff occurs.

11. The disk apparatus of claim 10, wherein
when the external power-supply cutoff occurs during write process of the data to be recorded, the controller saves at least part of the data in the nonvolatile memory and, after the power supply is resumed, rewrites the saved data to the disk medium.

12. The disk apparatus of claim 11, wherein
when a power-supply cutoff occurs while write process of the data to be recorded is performed collectively, the controller saves all of the data in the nonvolatile memory.

13. The disk apparatus of claim 11, wherein
when the external power-supply cutoff occurs while the multiple times of write process are performed, the controller saves the data block subjected to write operation coinciding with the timing of the power-supply cutoff, in the nonvolatile memory.

14. The disk apparatus of claim 11, wherein
when a power-supply cutoff occurs during period between a write operation and a next write operation out of multiple times of write operation, the controller saves data block subjected to write operation performed at immediately before a period during which the power-supply cutoff occurred in the nonvolatile memory.

15. A control method of a disk apparatus comprising:
obtaining amount of free space of a nonvolatile memory; and
performing write process of data to be recorded to a disk medium in the nonvolatile memory collectively or in multiple times, according to the obtained amount of the free space.

16. The control method of claim 15, wherein
the obtaining the amount of free space comprises obtaining amount of free space of the nonvolatile memory after write data subject to another write process to the disk medium is saved in the nonvolatile memory.

17. The control method of claim 15, wherein
the performing the write process comprises, when size of the data to be recorded is less than or equal to the amount of the free space, performing the write process of the data collectively and, when the size of the data is greater than the amount of the free space, performing the write process of the data in multiple times.

18. The control method of claim 17, wherein
the performing the write process in the multiple times comprises dividing the data to be recorded into multiple data blocks of a size less than or equal to the amount of the free space and performing multiple times of write operations that correspond to the multiple divided data blocks.

19. The control method of claim 15, further comprising: operating with using an auxiliary power supply when a cutoff of external power supply from outside the disk apparatus occurs.

20. The control method of claim 15, further comprising: when the cutoff of external power-supply occurs during write process of the data to be recorded, saving at least part of the data in the nonvolatile memory and, after the power supply is resumed, rewriting the saved data to the disk medium.
